(19) United States
(12) Patent Application Publication
(10) Pub. No.: US 2005/0264179 A1
(43) Pub. Date: Dec. 1, 2005

(54) Large-area electroluminescent light-emitting devices

(75) Inventors: Michael G. Mikhael, Tucson, AZ (US); Angelo Yializis, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(73) Assignee: Sigma Laboratories of Arizona, Inc., Tucson, AZ (US)

(21) Appl. No.: 11/137,823

(22) Filed: May 25, 2005

Related U.S. Application Data
(60) Provisional application No. 60/574,967, filed on May 27, 2004.

(51) Int. Cl. H05B 33/22; H05B 33/10; B05D 5/12

(52) U.S. Cl. 313/503; 313/504; 427/66

(57) ABSTRACT

An electroluminescent light-emitting device is manufactured in a semi-continuous process using vapor deposition technology to reduce the thickness of the dielectric layers. The phosphor, dielectric and electrode layers are deposited sequentially on a flexible web substrate, preferably PET coated with conductive ITO, which is passed through the deposition sections on a continuous basis. By depositing the dielectric layers in vacuum, very thin layers are possible, which yields increased transparency and electrical capacitance. Accordingly the resulting multi-layer structure is suitable for the manufacture of large-area EL devices.

### RELATED APPLICATIONS

This application is based on U.S. Provisional Application Ser. No. 60/574,967, filed on May 27, 2004.

### BACKGROUND OF THE INVENTION

1. Field of the Invention

This invention is related in general to the field of electronic solid state lights for displays, signage, backlights for electronic components, and general illumination. In particular, it pertains to electroluminescent displays and to methods for their manufacture by the sequential deposition of structural layers using polymer multi-layer technology.

2. Description of the Related Art

Electroluminescent (EL) light-emitting devices are generally constructed with an active electroluminescent phosphor layer (the light emitting layer) and one or more dielectric layers. The phosphor may itself be embedded in a layer of dielectric material. A transparent front electrode layer and a rear electrode layer complete the functional components of the devices. Thus, as illustrated schematically in FIG. 1, a typical EL lamp 10 consists of a front electrode layer 12 of a transparent or semi-transparent conductive material, typically indium tin oxide (ITO), formed on a transparent or semi-transparent substrate 14 via reactive vacuum sputtering. The substrate material, typically poly(ethylene terephthalate) (“PET”), polyester, or polycarbonate film, provides mechanical support for the other layers. The phosphor layer 16, consisting of an EL phosphor material, is screen printed onto the ITO layer and thermally cured. Immediately thereafter, a dielectric layer 18 is screen printed and thermally cured onto the phosphor layer. The rear electrode 20, generally consisting of a solvent-based silver emulsion, is screen printed and thermally cured onto the dielectric layer. Finally, EL light-emitting devices are normally sandwiched between two polymer layers 22,24, which are applied via vacuum lamination or other lamination techniques. These layers are generally designed to increase the life of the device by providing additional rigidity and resistance to abrasion, moisture and gas.

As is well understood in the art, EL devices are capable of becoming luminous when an AC voltage is applied between the electrode layers in those portions of the layers where the front and rear electrodes 12,20 overlap. While many applications require a single contiguous light source, such as backlighting for backlit signage and electronic devices, graphical overlays, others call for different regions of the EL device to be segmented and illuminated independently within a single EL panel. Thus, the front-electrode, phosphor, dielectric, and rear-electrode layers 12,16,18,20 may be patterned via screen printing to create more than one light-emitting region within a single EL device, effectively creating multiple segments, or regions, within a single EL device. These regions can be controlled individually with a multi-channel inverter or a power supply to create an animated effect. This process, known in the art as EL sequencing, is commonly used in signage for advertising, information displays, and other applications that utilize dynamic sequencing of separately illuminated regions within a single EL device.

U.S. Pat. No. 6,751,898 illustrates a segmented electroluminescent device, essentially as described, wherein sequencing of individual segments is provided by layered printed circuit and electronic components connecting the two electrode layers. The manufacture of such EL light-emitting devices typically involves screen-printing technologies that utilize sheet-fed substrates. Such processes are not suitable for continuous roll-to-roll construction. Therefore, they are limited in size and speed by the batch nature of the operation. Alternative methods, such as roll coating and rotary screen printing, have been used to deposit the phosphor layer 16, the dielectric layer 18, and the rear electrode 20. Unlike traditional screen printing, these alternative methods allow for some aspects of device construction to be conducted on a roll-to-roll basis. However, other aspects of device construction have necessarily required less efficient techniques, such as screen printing of the individual light-emitting regions required for patterned and sequential EL devices. All deposition steps include the manual application of conductive tape for connecting lights to electrode termination points and require manual lead bonding of termination points to inverter and power supply sub-assemblies. These various steps are not conducive to a relatively rapid manufacture of EL devices, especially large EL devices, in a substantially continuous operation

Another shortcoming in the art lies in the fact that increasingly larger EL devices require progressively higher currents to the electrode layers. The front electrode, which is normally made of ITO, is necessarily deposited as a thin layer in order to promote light transmission from the phosphor layer. Because the resistivity of ITO is relatively high (in the order of 10-300 ohm/square), its thickness has a significant effect on the electrical resistance of the transparent electrode, which tends to be considerably higher than that of the back electrode (which is higher than 0.01 ohm/square for most materials used in the art, though it could also be high if ITO or titanium are used in the back electrode). This reality presents a limiting factor as manufacturers increase overall device size—the greater the area of the device, the more difficult it becomes to deliver current across the plane of the front electrode.

In an effort to overcome this limitation, typically a heavy metal conductor with sufficiently higher conductivity than that exhibited by the front electrode is added to the edge of the electrode. This conductor, also referred to as a “busbar,” is applied directly to the front electrode along one or more sides of the EL device. The primary purpose of the busbar is to broaden the propagation of electrical current along the front electrode. The busbar is a common component in most EL devices and is typically applied as a separate screen-printed layer composed of a silver conductive paste, not unlike the material used to create the back cathode. Therefore, the addition of the busbar constitutes a further step that affects the speed and the continuity with which EL devices may be manufactured.

Finally, further limiting factors in the manufacture of large EL devices have been the thickness and the transparency of the dielectric layers. As is well understood in the art, the thickness of the dielectric layers affects the capacitance, and correspondingly the efficiency, of the EL device, as well as its transparency. Therefore, thinner dielectric layers enable the manufacture of larger devices with greater transparency and visibility of the intended light-emitted signal.

In view of the foregoing, there still exists a need for a process that allows the relatively rapid manufacture of large EL devices, especially in a substantially continuous operation. The present invention is based on the use of polymer multi-layer technology to achieve these goals. This technology was first described in U.S. Pat. No. 4,954,671.

### BRIEF SUMMARY OF THE INVENTION

In view of the foregoing, this invention is directed at the development of a semi-continuous process that is based primarily on the application of polymer multi-layer technology. According to one aspect of the invention, the deposition of the dielectric layer (or layers) is carried out by depositing and curing a clear radiation-curable monomer under vacuum. As a result, the dielectric layer is formed as a very thin film, thereby increasing its transparency with respect to the thicker dielectric layers heretofore deposited by screen printing or equivalent processes carried out at atmospheric conditions. Moreover, the capacitance of the resulting EL device is correspondingly increased by the smaller distance between the two electrodes in the device. In the preferred embodiment, the dielectric layer is deposited on both sides of the phosphor layer. Alternatively, a single thin-film, clear, dielectric layer may be deposited either in front or in the back of the phosphor layer.

In all cases, these layers are deposited on a flexible web substrate, preferably PET coated with conductive ITO, which is passed through each deposition section on a continuous basis. The deposition of the phosphor layer is carried out either conventionally, by screen printing or roll coating, or by depositing and curing a phosphor powder mixed with a radiation-curable monomer binder under atmospheric conditions. After the vacuum deposition of the dielectric layer (or layers) over the phosphor layer, the resulting multi-layer structure is coated with a highly conductive layer to form the back electrode (with resistivity less than 0.1 ohm/square, preferably in the order of 0.01 ohm/square). This step is preferably carried out by vapor deposition in a vacuum chamber. Alternatively, the metal layer may also be deposited and cured under atmospheric conditions as a mixture of metal powder with a radiation curable binder.

According to another aspect of the invention, all steps of each deposition phase are carried out continuously on a flexible web being spooled from roll to roll or on sheets fed continuously from a stack. Therefore, inasmuch as a substantial length of web material is contained in a roll (or sheet), the size of the ultimate device being manufactured is limited only by the width of the web (or sheet), which makes it possible to produce large electroluminescent displays on a semi-continuous basis. At each stage of deposition, the web's take-up roll (or the stack of sheets) is used as the feed roll in the next stage and is re-spooled on another take-up roll to produce a final roll of finished product. As a result of this approach, all steps required to manufacture an EL light-emitting device can be carried out in line in two or three continuous segments of operation, the only discontinuity resulting from the need to move the take-up roll from one segment into the feed-roll position in the next segment.

If desired, the last vacuum section may include units for the deposition of protective polymer layers on both sides of the structure. The multi-layer composite so produced can then be sectioned as needed to obtain individual devices.

According to yet another aspect of the invention, the continuous deposition of the phosphor and dielectric layers over the ITO electrode layer may be performed using a mask or equivalent device to prevent deposition over a predetermined portion of the ITO layer, preferably an edge swath on one or both sides of the web. The metal deposition of the back-electrode layer is then carried out so as to cover these exposed portions of the front ITO electrode, thereby creating a relatively large and continuous conductor along the edge of the ITO layer that may be used to increase the overall conductivity of the front layer. The back metallic layer is then segmented as necessary to isolate the edge and the portions intended to serve as the back electrode. Thus, the back electrode deposition also provides an extended conductor to increase the capacity of the front electrode to illuminate large-area EL devices.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiment and particularly pointed out in the claims. However, such drawings and description disclose but one of the various ways in which the invention may be practiced.

### BRIEF DESCRIPTION OF THE DRAWINGS

FIG. 1 is a schematic fragmentary section illustrating the multi-layer structure of an electroluminescent device.

FIG. 2 is a schematic representation of the various process units used to carry out the semi-continuous in-line process of the invention in two stages.

FIG. 3 is a schematic illustration of the web/electrode layers in a substrate suitable to practice the roll-to-roll deposition steps of the invention.

FIG. 4 is a schematic representation of the various process units used to carry out the semi-continuous in-line process of the invention in a three-stage embodiment.

FIG. 5 is a block diagram of the steps involved in practicing the preferred embodiment of the process of the invention.

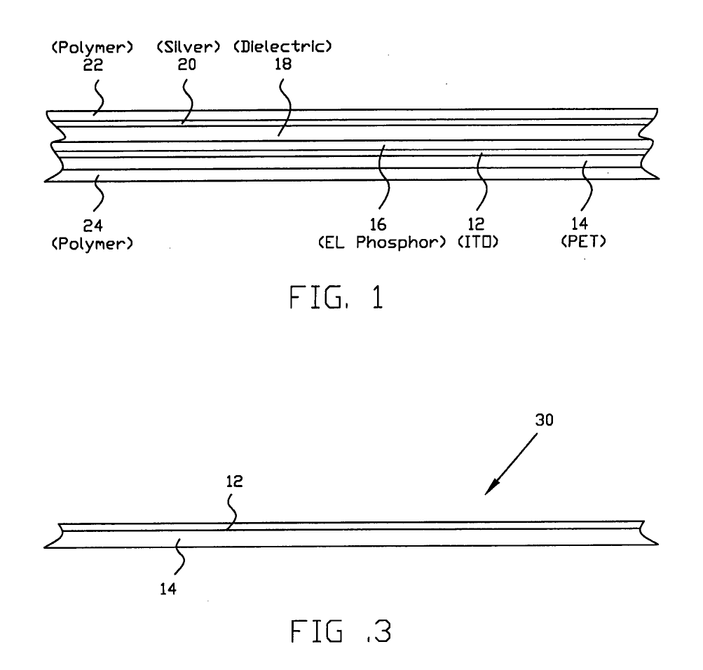

### DESCRIPTION OF THE PREFERRED EMBODIMENTS OF THE INVENTION

This invention evolved from a need to manufacture large electroluminescent light-emitting devices at a reasonable cost and with greater product efficiency than afforded by methods of the prior art. The invention lies primarily in the idea of using flash-evaporation/vacuum-deposition/radiation-curing technology to deposit the dielectric layers, thereby enabling the deposition of very thin, clear layers that promote the efficiency and transparency of the resulting EL multi-layer structures. This, in turn, makes it possible to achieve heretofore unattainable performance in large-area devices. Because these techniques can be carried out advantageously on a moving substrate, such large EL devices can also be produced continuously in line on a semi-continuous basis. Moreover, inasmuch as the conductivity limitations of the ITO layer become relevant as a result of the manufacture of larger devices, the invention advantageously also provides a solution to that problem.

As used herein, the term “web” is intended to refer to the moving substrate in the roll-to-roll processes of the invention as the web progresses through the various stages of deposition, regardless of the number of layers present at any given time. Accordingly, web is used to refer to the initial mono- or two-layer layer substrate spooled from a feed roll as well as to the various multi-layer structures produced after each stage of deposition, the context of the description being relied upon to distinguish between the various versions of the web after each stage, if necessary. The term “monomer” is used to refer to any of the polymerizable materials, including oligomers, used in the various deposition stages of the invention. The term “thin” used throughout in relation to the vacuum-deposited dielectric layer refers to thicknesses no greater then 3 micron, as can only be achieved by vapor deposition under vacuum conditions. Finally, “polymer multi-layer technology” is used to refer to the process by which a monomer is evaporated under vacuum (typically flash-evaporated), deposited over a substrate in vacuum, and then cured (by radiation or equivalent source) to form a polymeric film.

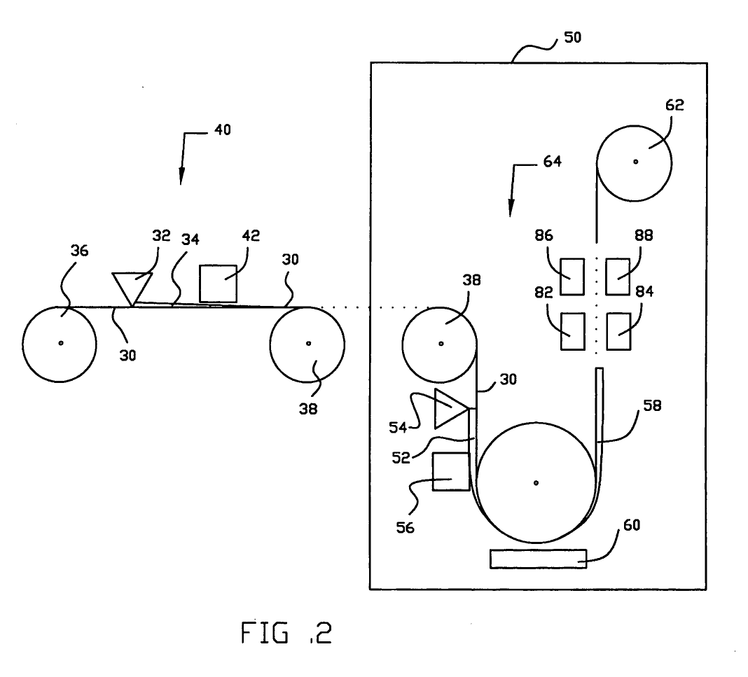

Referring to FIG. 2, the process of EL light-emitting device manufacture according to the invention is preferably carried out using a pre-fabricated two-layer roll of substrate 30. Typically, as shown in the fragmentary view of FIG. 3, this substrate consists of a bottom web 14 made of 1-7 mil PET coated with a thin film 12 of 200-1000 Å clear ITO, which serves as one of the electrodes of the EL device. This two-layer substrate 30 is first screen printed in a deposition station 32 with a phosphor layer 34. This step may be carried out in conventional manner, using a solvent-based EL phosphor material that is deposited and then cured by exposure to heat passing through an oven or other heating unit 42. The deposition of the phosphor layer 34 over the ITO layer 12 is carried out as the web of substrate material 30 is moved from a feed roll 36 to a take-up roll 38 at the other end of a first continuous process line 40.

Alternatively, the phosphor layer 34 may be screen printed from a mixture consisting of an EL phosphor powder and a radiation-curable monomer (or oligomer), such as an acrylate, a methacrylate, an epoxy, a vinyl, or an olefin. The phosphor layer so deposited is immediately exposed to a radiation source, such as an electron-beam or a UV unit, to fully cure the polymeric binder as the web of substrate material 30 is moved from roll to roll. Other methods of deposition, such as roll coating and draw down, may be used in the same manner to form the EL layer 34 and, as would be known to one skilled in the art, the viscosity of the phosphor blend would have to be tailored to the particular deposition technique. Acrylated oligomers that provide good wetting for the phosphor particles and fall in the right viscosity range are preferred. Surfactants and leveling agents should be added to facilitate the coating of the phosphor over the ITO layer 12. Finally, a suitable photoinitiator is added to the phosphor mixture for radiation curing. A mixture of two or three initiators may be used to enhance both surface and bulk curing at the process speed of the moving web (which may be in excess of 50 fpm).

According to the invention, the dielectric layer separating the phosphor layer from the back electrode should be as thin as possible in order to increase the capacity of the electrode layers and correspondingly the efficiency of the EL device. Therefore, the dielectric layer is deposited in vacuum, which permits the flash evaporation of the dielectric material (such as any monomer used in the art) and its direct deposition as a very thin film (preferably 0.5-1.0 micron) that is then radiation-cured in conventional manner.

In order to effect this thin-film deposition step, the take-up roll 38 is transferred to a vacuum chamber 50 wherein the dielectric layer and the back-electrode layer of the EL structure are deposited in a second continuous process stage. A dielectric layer 52 is first deposited using a conventional flash-evaporation/vapor-deposition unit 54 and immediately cured with a radiation source 56 (such as an electron-beam or a UV unit). A layer 58 of metal is then deposited on the moving web 30 in the vacuum chamber 50 using a metal deposition unit 60, such as an aluminum resistive evaporator. The multi-layer web 30 is spooled through a conventional rotary drum and collected by another, final take-up roll 62 at the end of this second continuous process line 64.

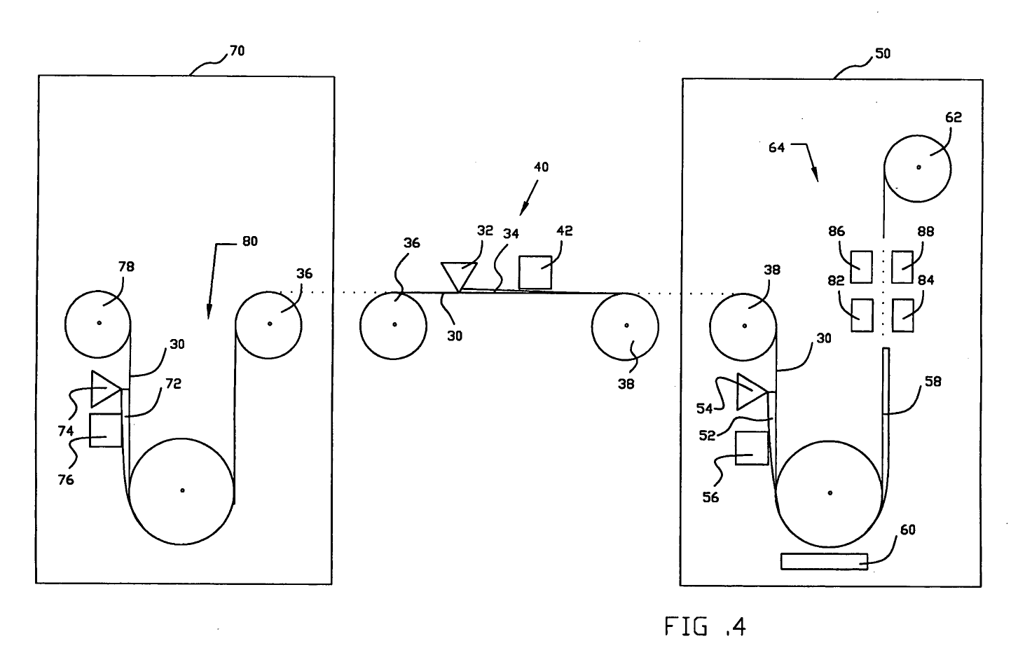

It may be advantageous to strengthen the front side of the phosphor layer 34 by depositing another thin layer of transparent dielectric material between the ITO electrode 12 and the phosphor layer. This must also be carried out in vacuum because such an additional dielectric layer needs to be particularly thin and clear. Therefore, when such a front protective layer is desired, it is preferred to deposit it directly over the ITO layer when the web used for the invention (in roll or sheet form) is initially manufactured. Otherwise, as illustrated in FIG. 4, it may be deposited in an additional continuous stage of operation in a vacuum chamber 70 (which, of course, could be the same as the chamber 50 used in the last stage of deposition). As shown in the figure, this additional dielectric layer 72 is deposited with a flash-evaporation/deposition unit 74 and immediately cured with a radiation source 76 as the web 30 is being spooled continuously from an original substrate/ITO feed roll 78 to the roll 36 in this additional continuous process line 80. The roll 36 is then used as the feed roll in the subsequent phosphor-layer deposition stage. The rest of the process to deposit the back dielectric layer 52 and the metal layer 58 remains the same. It is noted that the second dielectric layer 52 (on the back side of the phosphor layer 34) can be eliminated when the front dielectric layer 72 is deposited on the ITO layer, as in the case illustrated in FIG. 4

An additional deposition step may be carried out to deposit a polymeric protective layer on either or both sides of the web 30 in line under vacuum (as illustrated by deposition units 82,84 and corresponding curing units 86,88 in the vacuum chamber 50 of FIGS. 2 and 4). These layers could also be deposited in a separate processing stage (not shown) carried out under atmospheric conditions using a radiation curable monomer screen printed and cured as described above with reference to the phosphor layer.

The vacuum deposition of the metal electrode layer 58 may be replaced by an atmospheric lamination process. In such cases, a thicker dielectric layer (in the order of 10-30 micron) is deposited in conventional manner at atmospheric conditions (rather than in vacuum) and is only partially cured (i.e., B-staged). The dielectric layer is then laminated with a metal foil also at atmospheric conditions. For example, the process starts with a roll of PET film coated with ITO; a phosphor layer is deposited; a partially cured dielectric layer is deposited; aluminum foil is laminated on top of the partially cured layer; and heat or pressure is applied to the laminate to allow it to become fully cured. The resulting device is an efficient and relatively inexpensive electrode that provides improved conductivity and barrier over the prior art. Alternatively, the partially cured dielectric layer 52 is laminated with another PET/ITO film 30 for double side service. Therefore, use of this partial curing (B-staging) technique provides a vehicle for the production of various new and inexpensive EL materials.

For a double-sided EL device, two multi-layer sheets composed of the structure “PET/ITO/phosphor-layer/partially-cured-dielectric-layer” are produced and laminated to each other at the dielectric sides. Then, curing is completed with heat and/or pressure. Such a device has two clear electrodes, one on each side.

In a similar process, the invention may also be practiced in batch operation to manufacture 3-D electroluminescent devices. Such devices are constructed by depositing a metal layer on a rotating 3D object. The phosphor layer is preferably deposited by dipping the object in the same type of material described above and curing it (either by UV or heat). The dielectric layer is deposited in vacuum, as illustrated above, while rotating the object and the top clear electrode is then deposited by sputtering the rotating object with ITO.

In all cases, the metal electrode may also be segmented to form various shapes, which allows control of the active light area in a dynamic way. To that end, a laser source (or any other etching device) may be used to remove the metal and draw different segments in a procedure that can generally also be performed during the continuous roll-to-roll process described above. Finally, the various devices produced according to this invention may be encapsulated and packaged with edge protection and barrier structures as disclosed in U.S. Ser. No. 10/838,701, filed May 4, 2004, herein incorporated by reference.

According to the invention, the final EL light-emitting structure may thus consist of any one of the following multi-layer combinations:
PET/ITO/phosphor (atmospheric)/dielectric (vacuum)/metal (vacuum)
PET/ITO/phosphor (atmospheric)/dielectric (vacuum)/metal (atmospheric)
PET/ITO/dielectric (vacuum)/phosphor (atmospheric)/dielectric (vacuum)/metal (vacuum)
PET/ITO/dielectric (vacuum)/phosphor (atmospheric)/dielectric (vacuum)/metal (atmospheric)
PET/ITO/dielectric (vacuum)/phosphor (atmospheric)/metal (vacuum)
PET/ITO/dielectric (vacuum)/phosphor (atmospheric)/metal (atmospheric)

UV-cured polymers (such as acrylates, methacrylates, epoxies, vinyls, or olefins) and conventional binders for the phosphor layer are compatible with organic dyes. Thus, the color of the EL light may be enhanced or altered in straightforward manner by including colorant material (clear organic dyes) either in the dielectric layer or in the binder of the phosphor layer. Formulations with different colors may be developed for enhanced light sources. Fluorescent material may similarly be used either mixed with the dielectric material or as a separate screen-printed layer on top of it or on top of the PET substrate of the web in order to increase the brightness of the white light produced by the EL device.

Thus, the efficiency of the devices manufactured with the deposition techniques of the invention is enhanced by the use of thin-film radiation-curable material with a high dielectric constant (K=3-16) deposited in vacuum. Such thin-films (1-3 micron) of vacuum-deposited/radiation-cured cyano (CN) functionalized acrylate monomers, for example, were found to increase markedly the dielectric constant of the device (i.e., from 33.70 to 136.0), which resulted in higher capacitance and efficiency of operation.

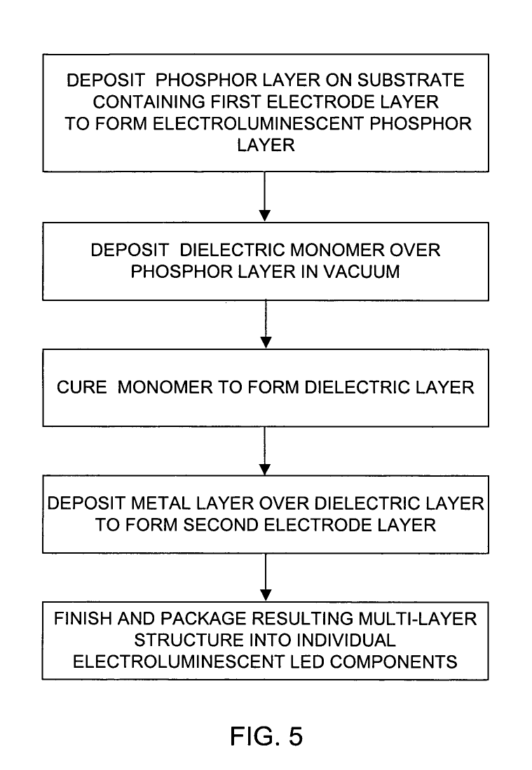

FIG. 5 illustrates in block-diagram form the various steps involved in carrying out the concept of the invention in one of its preferred embodiments. The following examples demonstrate various EL light-emitting devices manufactured according to the invention.

### EXAMPLE 1

An EL-LED structure was manufactured in line using the arrangement of FIG. 2, wherein a screen printing unit was used to deposit the phosphor layer at atmospheric conditions over a web in a process line moving at a speed of 50 feet per minute between a feed roll and a take-up roll. The phosphor layer was cured with a 300 W/inch low pressure UV lamp. The dielectric and metal layers were deposited in a vacuum chamber operating at 3×10⁻⁴ torr with a conventional flash-evaporation/vapor-deposition unit and a wire feed resistive evaporator over a web moving at a speed of 300 feet per minute. The materials used at each stage of layer deposition were as follows:
Substrate: 3 mil PET coated with ITO, surface resistance 60 ohm/sq.
Phosphor: 25 micron, from a mixture of diacrylate monomer with blue/green phosphor powder
Dielectric: 0.2 micron, clear dielectric film (12 dielectric constant), from an acrylate-based monomer
Metal: about 300 A of aluminum

The resulting structure was connected to an AC power supply and tested. The device showed bright uniform blue/green light.

### EXAMPLE 2

An EL-LED structure was manufactured in line using the phosphor and dielectric materials of Example 1, but the dielectric layer was screen printed in conventional manner in a thickness of about 17 micron and the curing stage was limited to B staging. The partially cured dielectric layer was then laminated with a metal foil, which consisted of the laminated aluminum foil. The resulting structure was connected to an AC power supply and tested. The device showed bright uniform blue/green light.

### EXAMPLE 3

An EL-LED structure was manufactured as detailed for Example 2, again limiting the curing stage of the dielectric layer to B staging (15 micron thick). Two identical sheets with partially cured dielectric layers were then laminated to each other, thereby forming a structure with clear PET/ITO on both sides. The materials used at each stage were as follows:
Substrate: same as Example 1
Phosphor: same as Example 1
Dielectric: B staged, same as Example 2
No metal layer

The resulting structure was connected to AC power supply and tested for both side light emission. The device showed uniform bright blue lights on both sides.

### EXAMPLE 4

An EL-LED structure was manufactured again as in Examples 2 and 3, with a dielectric layer 20 micron thick, limiting the curing stage of the dielectric layer to B staging. Then, the sheet with partially cured dielectric layers was laminated with another substrate layer (with the ITO facing the dielectric layer), thereby again providing a structure with clear PET/ITO on both sides.

### EXAMPLE 5

Several devices similar to that of Example 1 were prepared with a dielectric layer containing 1-10% of fluorescent material to alter the brightness of the emitted light and create a white light. The resulting devices produced bright white light.

### EXAMPLE 6

Several devices similar to that of Example 4 were prepared, but a layer of fluorescent material was screen printed on top of the PET substrate after depositing the metal electrode in vacuum. The resulting devices also produced bright white light.

### EXAMPLE 7

Several devices similar to that of Example 1 were prepared with a dielectric layer containing 5-10% of organic dyes (yellow and red) to alter the color of the emitted light and create a broader range of colored light. Both sets of runs produced devices with these characteristics.

### EXAMPLE 8

A device similar to that of Example 1 was prepared with a phosphor layer prepared with a high dielectric cyano-acrylate binder (>10 dielectric constant), which increased the capacitance and enhanced the device performance and brightness.

### EXAMPLE 9

A device similar to that of Example 1 was prepared where protective barrier sheets were laminated on both sides of the device. That increased the durability of the device and enhanced the device's performance and brightness.

### EXAMPLE 10

Several devices similar to that of Example 1 were prepared using the vacuum/atmospheric/vacuum arrangement of FIG. 4. In each case, a vacuum-deposited thin (0.2-2.0 micron) clear dielectric film (>10 dielectric constant) was deposited on the ITO layer prior to the deposition of the phosphor layer. Another dielectric layer and a metal layer were then deposited in vacuum over the phosphor layer. That increased the reliability and the capacitance of the devices, thereby also enhancing their performance and brightness.

### EXAMPLE 11

Several devices similar to those of Example 10 were prepared, but the thin (0.2-2.0 micron) clear dielectric film (>10 dielectric constant) was vacuum deposited only on one side of the phosphor layer (between the ITO and the phosphor layers). The increased capacitance and enhanced performance and brightness of the device were retained in all cases.

### EXAMPLE 12

A 3-D device was prepared by vacuum metallization of a glass bottle with an aluminum layer. The metalized bottle was subsequently dipped in a blend of phosphor powder with acrylate monomers and a photoinitiator. Then the coating was cured with UV radiation. A layer of dielectric material and a layer of clear conductive ITO were deposited on top of the phosphor layer by vapor deposition and by vacuum sputtering, respectively. The device was connected to an AC source and tested for brightness and uniformity.

### EXAMPLE 13

Another 3-D device was prepared by vacuum metallization of a glass bottle with an aluminum layer. The metallized bottle was subsequently dipped in a blend of phosphor powder with acrylate monomers and a photoinitiator. Then the coating was cured with UV radiation. A layer of thin clear dielectric polymer was deposited in vacuum and cured with an electron beam. A layer of clear conductive ITO was deposited on top of the dielectric layer by vacuum sputtering. The outer dielectric layer was then segmented by removing some of the ITO layer. The device was connected to an AC source and tested to show patterns of bright and uniform light corresponding to the segmented patterns.

Thus, a novel approach has been described for manufacturing EL-LED multi-layer structures in a rapid semi-continuous coating/curing process. The color of the EL light may be altered by including either a colorant material (clear organic dyes) or a fluorescent material in the binder of the phosphor and/or the dielectric layers. Moreover, the efficiency of the device may be enhanced by using thin radiation-curable materials with a high dielectric constant (K=10-16). The EL light-emitting structures so produced may be completed by alternative laminating options, such as by partial curing (B-staging) of the dielectric layer and laminating it with metal foil as an electrode, or by partial curing (B-staging) of the dielectric layer and laminating it with another PET/ITO film for double-sided devices.

Three-dimensional EL devices may also be produced in similar fashion. That is, a 3-D object is first covered with a metal electrode, then by a phosphor layer, a dielectric layer, and finally by a top clear electrode, as disclosed. Laser segmentation or any other etching technique of the back metal electrode may also be used for signs and dynamic signs, both in the 3-D and the roll-to-roll implementations of the invention. All devices may also be packaged or encapsulated in conventional manner between barrier sheets.

Finally, the process of the invention lends itself advantageously for the in-line formation of an edge bus to increase the conductivity of the ITO layer in the final EL devices. This is achieved by masking or otherwise protecting one or both edges of the ITO layer as the phosphor and the dielectric layers are being deposited. These exposed sections of the ITO layer are covered with metal in the metallization step that produces the back electrode of the EL device, thereby providing a conductive strip on the ITO layer along the entire edge on one or both sides of the running web. During the segmentation step, this strip is separated from the rest of the back cathode layer and remains exposed for connection to appropriate hardware through which the device is powered with an AC source.

Therefore, while the present invention has been shown and described herein in what is believed to be the most practical and preferred embodiments, it is recognized that departures can be made therefrom within the scope of the invention. For example, plasma treatment of the ITO surface may be added prior to the step of deposition of a dielectric or phosphor layer over the ITO. Such a process is used to improve adhesion of the next layer over the ITO-bearing web. Therefore, it may be preferred in some instances. Thus, the invention is not to be limited to the details disclosed herein but is to be accorded the full scope of the claims so as to embrace any and all equivalent processes and products.

1. A method for manufacturing a multi-layer electroluminescent device, comprising the following steps:
(a) depositing a mixture including an electroluminescent material to form an electroluminescent layer over a substrate including a first transparent electrode having a resistivity greater than 10 ohm per square;
(b) vacuum depositing and curing a thin monomer dielectric layer with a dielectric constant greater than 3 over the electroluminescent; and
(c) depositing a second electrode layer over said dielectric layer, thereby producing a multi-layer electroluminescent structure.

2. The method of claim 1, wherein said dielectric layer includes a monomer that is radiation cured.

3. The method of claim 1, wherein said second electrode layer is deposited in vacuum.

4. The method of claim 3, wherein said second electrode layer is aluminum.

5. The method of claim 1, wherein said substrate is a moving web and said steps (a) through (c) are carried out on the moving web.

6. The method of claim 1, wherein a portion of said first electrode layer is left exposed during steps (a) and (b), and step (c) includes depositing said second electrode layer over said exposed portion of the first electrode layer.

7. The method of claim 6, further including the step of segmenting said second electrode layer to form electroluminescent light-emitting regions that are electrically isolated from the first electrode.

8. The method of claim 1, further including the step of vacuum depositing a polymeric protective layer over at least one of said substrate and said second electrode layer following step (c).

9. The method of claim 1, further including the step of finishing and packaging said multi-layer electroluminescent structure to produce an electroluminescent device.

10. The method of claim 1, wherein said mixture includes a colorant material.

11. The method of claim 1, wherein said mixture includes a fluorescent material.

12. The method of claim 1, further including the step of depositing a fluorescent layer over said substrate.

13. The method of claim 1, further including the step of plasma treating said first electrode layer prior to step (a).

14. The method of claim 2, wherein said substrate is a moving web and steps (a) through (c) are carried out on the moving web; said second electrode layer is aluminum; a portion of said first electrode layer is left exposed during steps (a) and (b), and step (c) includes depositing said second electrode layer over said exposed portion of the first electrode layer; and said second electrode layer is segmented to form electroluminescent light-emitting regions that are electrically isolated from the first electrode.

15. A method for manufacturing a multi-layer electroluminescent device, comprising the following steps:
(a) vacuum depositing and curing a thin, monomer, first dielectric layer with a dielectric constant greater than 3 over a substrate including a first transparent electrode having a resistivity greater than 10 ohm per square;
(b) depositing a mixture including an electroluminescent material to form an electroluminescent layer over said first dielectric layer;
(c) vacuum depositing and curing a thin, monomer, second dielectric layer with a dielectric constant greater than 3 over the electroluminescent; and
(d) depositing a second electrode layer over said dielectric layer, thereby producing a multi-layer electroluminescent structure.

16. The method of claim 15, wherein said first and second dielectric layer include a monomer that is radiation cured.

17. The method of claim 15, wherein said second electrode layer is deposited in vacuum.

18. The method of claim 17, wherein said second electrode layer is aluminum.

19. The method of claim 15, wherein said substrate is a moving web and said steps (a) through (d) are carried out on the moving web.

20. The method of claim 15, wherein a portion of said first electrode layer is left exposed during steps (a) through (c), and step (d) includes depositing said second electrode layer over said exposed portion of the first electrode layer.

21. The method of claim 20, further including the step of segmenting said second electrode layer to form electroluminescent light-emitting regions that are electrically isolated from the first electrode.

22. The method of claim 15, further including the step of vacuum depositing a polymeric protective layer over at least one of said substrate and said second electrode layer following step (d).

23. The method of claim 15, further including the step of finishing and packaging said multi-layer electroluminescent structure to produce an electroluminescent device.

24. The method of claim 15, wherein said mixture includes a colorant material.

25. The method of claim 15, wherein said mixture includes a fluorescent material.

26. The method of claim 15, further including the step of depositing a fluorescent layer over said substrate.

27. The method of claim 15, further including the step of plasma treating said first electrode layer prior to step (a).

28. The method of claim 16, wherein said substrate is a moving web and steps (a) through (d) are carried out on the moving web; said second electrode layer is aluminum; a portion of said first electrode layer is left exposed during steps (a) through (c), and step (d) includes depositing said second electrode layer over said exposed portion of the first electrode layer; and said second electrode layer is segmented to form electroluminescent light-emitting regions that are electrically isolated from the first electrode.

29. A method for manufacturing a multi-layer electroluminescent device, comprising the following steps:
(a) vacuum depositing and curing a thin, monomer, dielectric layer with a dielectric constant greater than 3 over a substrate including a first transparent electrode having a resistivity greater than 10 ohm per square;
(b) depositing a mixture including an electroluminescent material to form an electroluminescent layer over said first dielectric layer; and
(c) depositing a second electrode layer over said dielectric layer, thereby producing a multi-layer electroluminescent structure.

30. The method of claim 29, wherein said dielectric layer includes a monomer that is radiation cured.

31. The method of claim 29, wherein said second electrode layer is deposited in vacuum.

32. The method of claim 31, wherein said second electrode layer is aluminum.

33. The method of claim 29, wherein said substrate is a moving web and said steps (a) through (c) are carried out on the moving web.

34. The method of claim 29, wherein a portion of said first electrode layer is left exposed during steps (a) and (b), and step (c) includes depositing said second electrode layer over said exposed portion of the first electrode layer.

35. The method of claim 34, further including the step of segmenting said second electrode layer to form electroluminescent light-emitting regions that are electrically isolated from the first electrode.

36. The method of claim 29, further including the step of vacuum depositing a polymeric protective layer over at least one of said substrate and said second electrode layer following step (c).

37. The method of claim 29, further including the step of finishing and packaging said multi-layer electroluminescent structure to produce an electroluminescent device.

38. The method of claim 29, wherein said mixture includes a colorant material.

39. The method of claim 29, wherein said mixture includes a fluorescent material.

40. The method of claim 29, further including the step of depositing a fluorescent layer over said substrate.

41. The method of claim 29, further including the step of plasma treating said first electrode layer prior to step (a).

42. The method of claim 30, wherein said substrate is a moving web and steps (a) through (c) are carried out on the moving web; said second electrode layer is aluminum; a portion of said first electrode layer is left exposed during steps (a) and (b), and step (c) includes depositing said second electrode layer over said exposed portion of the first electrode layer; and said second electrode layer is segmented to form electroluminescent light-emitting regions that are electrically isolated from the first electrode.

43. A method for manufacturing a multi-layer electroluminescent device, comprising the following steps:
(a) depositing a mixture including an electroluminescent material to form an electroluminescent layer over a substrate including a first transparent electrode having a resistivity greater than 10 ohm per square;
(b) depositing a monomer with a dielectric constant greater than 3 over the electroluminescent layer;
(c) partially curing said monomer to produce a partially cured dielectric layer; and
(d) laminating a second electrode layer over the partially cured dielectric layer, thereby producing a multi-layer electroluminescent structure.

44. The method of claim 43, wherein said second electrode layer is a metal foil.

45. The method of claim 43, wherein said second electrode layer is a second substrate including a conductive layer adhered to the partially cured dielectric layer to form said second electrode layer.

46. The method of claim 43, wherein said second electrode layer is a second electroluminescent structure including a second partially cured dielectric layer, said second electroluminescent structure being produced by repeating steps (a) through (c) in a separate operation over a second substrate containing a second electrode layer.

47. A method for manufacturing a multi-layer electroluminescent device, comprising the following steps:
(a) vacuum depositing and curing a thin, monomer, first dielectric layer with a dielectric constant greater than 3 over a substrate including a first transparent electrode having a resistivity greater than 10 ohm per square;
(b) depositing a mixture including an electroluminescent material to form an electroluminescent layer over said first dielectric layer;
(c) depositing a monomer with a dielectric constant greater than 3 over the electroluminescent layer;
(d) partially curing said monomer to produce a partially cured dielectric layer; and
(e) laminating a second electrode layer over the partially cured dielectric layer, thereby producing a multi-layer electroluminescent structure.

48. The method of claim 47, wherein said second electrode layer is a metal foil.

49. The method of claim 47, wherein said second electrode layer is a second substrate including a conductive layer adhered to the partially cured dielectric layer to form said second electrode layer.

50. The method of claim 47, wherein said second electrode layer is a second electroluminescent structure including a second partially cured dielectric layer, said second electroluminescent structure being produced by repeating steps (a) through (d) in a separate operation over a second substrate containing a second electrode layer.

51. An electroluminescent device manufactured according to the method of claim 1.

52. An electroluminescent device manufactured according to the method of claim 14.

53. An electroluminescent device manufactured according to the method of claim 15.

54. An electroluminescent device manufactured according to the method of claim 28.

55. An electroluminescent device manufactured according to the method of claim 29.

56. An electroluminescent device manufactured according to the method of claim 42.

57. An electroluminescent device manufactured according to the method of claim 43.

58. An electroluminescent device manufactured according to the method of claim 47.
